(19) United States
(12) Patent Application Publication
(10) Pub. No.: US 2005/0213932 A1
(43) Pub. Date: Sep. 29, 2005

(54) Video recorder and method for configuring a recording time

(76) Inventors: Hiroyuki Yuri, Ebina (JP); Keita Itoh, Fujisawa (JP); Motoyuki Suzuki, Fujisawa (JP); Koki Abe, Fujisawa (JP); Yoshihiro Machida, Yokohama (JP); Masayuki Inoue, Yokohama (JP); Kentaro Hirano, Ebina (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/044,565

(22) Filed: Jan. 28, 2005

(30) Foreign Application Priority Data
Mar. 25, 2004 (JP) 2004-088303

(51) Int. Cl. H04N 5/76; H04N 5/781

(52) U.S. Cl. 386/46; 386/125

(57) ABSTRACT

A video recording apparatus, wherein the electronic program table data of a broadcast program is acquired, and in response to a recording instruction for the broadcast program while viewing, the broadcast end time of the broadcast program recorded is acquired from the electronic program table data, so that the video information is recorded until the program end time from the time of the recording instruction. In the case where the broadcast program is delayed, the sum of the broadcast end time of the broadcast program to be recorded and a predetermined delay time is determined as the recording end time. From the time of the recording instruction to the program end time, the video information is recorded.

### BACKGROUND OF THE INVENTION

The present invention relates to a video recording apparatus for recording the video information such as the TV broadcast, or in particular to a video recording control method.

In recent years, the use of the video recording apparatus has extended in which the video information such as the TV broadcast are compressed in band using the image compression technique of MPEG or the like and the compressed video information are stored in a built-in medium including a hard disk or a DVD-RAM.

Some of these video recording apparatuses, like VTR, have the recording reservation function for designating the channel and the recording time zone, and further acquiring an electronic program table (EPG) through the TV broadcast or a network thereby to easily make reservation for video recording. Various video recording methods using EPG have been conceived. JP-A-2001-36861, for example, discloses a method of selecting the video recording mode based on the program type information of EPG. In these video recording apparatuses, an instruction can be given by a remote controller or the like to start the video recording, thereby recording a program while viewing another program.

In the TV broadcast, the broadcast time of a program may be extended or the contents of the broadcast may be changed immediately before broadcast. As a result, it sometimes happens that a broadcast program reserved for recording cannot be recorded normally. As described in JP-A-8-306097, therefore, a method has been conceived in which the time extension setting unit of the remote controller is operated and the video recording time is extended in accordance with the number of times the time extension setting unit is operated whenever the recording end time is set erroneously or the broadcast end time is extended.

### SUMMARY OF THE INVENTION

The conventional technique described above improves the convenience of the video recording reservation, but fails to take into consideration the manual video recording operation for a program while viewing. A method is disclosed in JP-A-8-306097, wherein the recording time is set in accordance with the number of times the recording button is depressed while viewing a program. In this method, only predetermined units of recording time can be set, and therefore the problem is posed that even the unrequited program after the end of an intended program as well as the intended program is recorded. In the case where the number of times the recording button is depressed is not sufficient, the broadcast program desired to be recorded may not be recorded up to the end time.

Also, the conventional technique disclosed in JP-A-8-306097 poses the problem that in the case where the extension time of the broadcast program is not known, the number of times the extension setting unit of the remote controller is operated is unknown, and therefore the repeated operation is required after the end of an operation, thereby deteriorating the operability.

The object of this invention is to solve the above-mentioned problems by providing a video recording apparatus capable of recording up to the end of a program easily even in the case where the manual recording operation is performed while viewing a program.

In order to achieve this object, according to this invention, there is provided a video recording apparatus wherein an electronic program table data of a broadcast program is acquired, and upon instruction to record the broadcast program being viewed, the broadcast end time of the broadcast program to be recorded is acquired from the electronic program table data, so that the video information is recorded from the time of the recording instruction to the broadcast end time of the particular program.

In the case where the broadcast program is delayed, on the other hand, the broadcast end time of the program to be recorded, plus a predetermined delay time, is set as the recording end time, so that the video information continues to be recorded from the time of the record instruction to the program end time.

Further, the recording up to the broadcast end time acquired from the electronic program table, the recording up to the broadcast end time acquired form the electronic program table plus the predetermined delay time or the recording for a predetermined time is sequentially displayed for selection. Further, the validity of the electronic program table is determined, and whenever it is invalid, the recording to the broadcast end time acquired from the electronic program table is not displayed for selection.

### BRIEF DESCRIPTION OF THE DRAWINGS

FIG. 1 is a block diagram showing a configuration of a video recording apparatus.

FIG. 2 shows an example of the configuration of the electronic program table (EPG).

FIGS. 3A, 3B, 3C briefly show the manner in which the recording end time is set.

FIG. 4A, 4B, 4C, 4D show an example of the recording end time displayed.

FIG. 5 shows the flow of setting the recording end time.

### DESCRIPTION OF THE EMBODIMENTS

An embodiment of the invention is explained below with reference to the accompanying drawings.

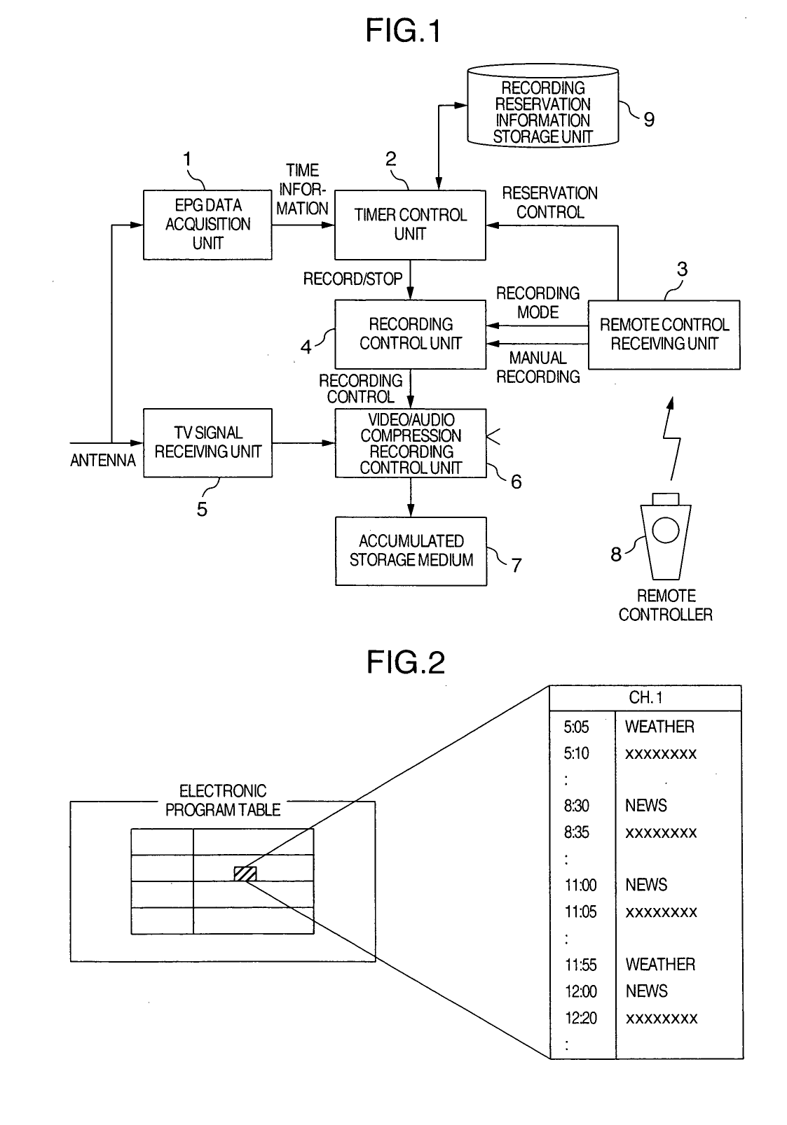

FIG. 1 is a block diagram showing a configuration of the video recording apparatus according to an embodiment. A TV signal receiving unit 5 acquires the video/audio information contained in the TV broadcast wave through an antenna, and displays a broadcast program on a display unit not shown. The information thus acquired is compressed in band by the video compression technique such as MPEG in a video/audio compression recording control unit 6, and stored in an accumulated storage medium 7. The accumulated storage medium 7 is configured of a hard disk or a removable disk such as DVD-RAM, and adapted to store a plurality of broadcast programs by MPEG compression.

The EPG data acquisition unit 1 acquires the program information data contained in the TV broadcast wave received through the antenna and determines the broadcast channel information, the time information and the program information.

In this video recording apparatus, an operating instruction is received from the remote controller 8 by a remote control receiving unit 3, and in accordance with the contents of the instruction, the timer control unit 2, the recording control unit 4 or the video/audio compression recording control unit 6 are controlled, thereby recording the broadcast program or displaying the program for viewing.

In the timer control unit 2, the program table acquired by the EPG data acquisition unit 1 is displayed as a radio-TV column, and in accordance with the operating instruction from the remote controller 8, the recording reservation is set, and the recording reservation information is stored in the recording reservation information recording unit 9. In the timer control unit 2, a recording start instruction is issued to the recording control unit 4 at a predetermined time based on the recording reservation information thereby to start the video recording of the broadcast program. Upon the arrival of the set end time, a recording end instruction is issued to the recording control unit 4 thereby to end the recording of the broadcast program. The recording reservation information recording unit 9 may be incorporated as a part of the accumulated storage medium 7.

The recording control unit 4 sets the compression mode for band compression such as MPEG performed in the video/audio compression recording control unit 6 in response to a recording mode instruction from the remote controller. The recording mode includes the long play mode (LP), the standard mode (SP) and the high image quality mode (HQ), in accordance with each of which the bit rate is changed for MPEG compression. In LP mode, the bit rate is set low to make possible the long-time recording. In HQ mode, on the other hand, the recording of high image quality is made possible, though short in recordable time. These image quality modes may be set either for each recording session while viewing or as a fixed value. The recording mode can also be set for each recording reserved program, so that a timer control unit 2 sets the recording mode for each program unit at the time of recording reservation. In this case, the program may be stored as part of the recording reservation information in the recording reservation information storage unit 9.

In the recording control unit 4, the broadcast program received by the TV signal receiving unit 5 and displayed on the display unit not shown is compressed by the video/audio compression recording control unit 6 and stored in the accumulated storage medium 7 in response to the recording instruction from the remote controller while viewing the program. In the process, the recording control unit 4, as described in detail later, displays the recording time on the display unit not shown to permit the viewer to set the recording time.

The operating instruction can be issued to the video recording apparatus not only from the remote controller 8 but also from the operation panel of the apparatus or any other device having the function of connecting a network, or for example, from a terminal such as a PC connected through the network to the video recording apparatus.

Next, an example of the structure of the EPG data is explained with reference to FIG. 2. The EPG data is configured of the broadcast time and the name of the broadcast programs and the brief contents of the broadcast programs for each channel. The EPG data is distributed for the scheduled future broadcast programs as well as the current broadcast programs, and utilized for recording reservation by the video recording apparatus. As described above, in the case where the EPG data is contained as part of the broadcast wave, the data are distributed several times a day. The data may additionally be distributed through the internet.

By accessing the EPG data from the channel number of the broadcast program currently viewed and the present time, the broadcast program being viewed can be identified. Further, the end time of the same broadcast program can be determined from the EPG data.

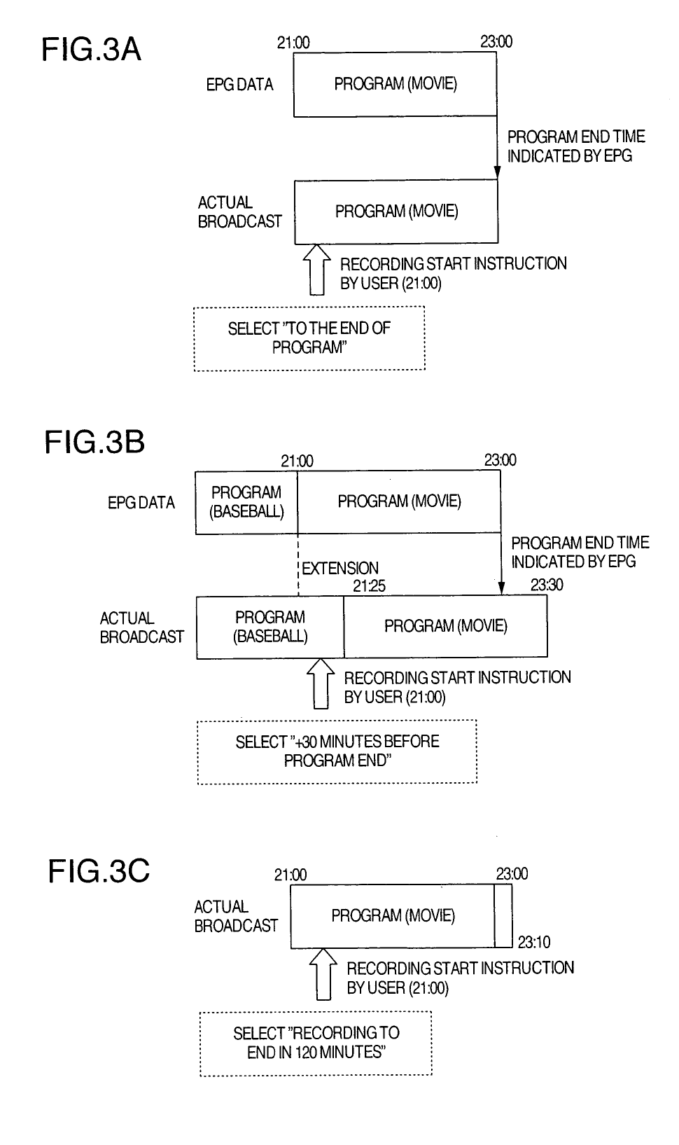

Next, a method of setting the recording end time is briefly explained with reference to FIGS. 3A, 3B, 3C, referring to a case where the broadcast program now being viewed is recorded using the remote controller.

FIG. 3A shows a case in which the EPG data conforming to the currently broadcast program is existent. Assume that the program (movie) is broadcast from 21:00 and the viewer issues a recording instruction by the remote controller at 21:10. The recording control unit 4 of the video recording apparatus recognizes the broadcast channel of the broadcast program being viewed and the present time and refers to the EPG data. As a result, the recording control unit 4 specifies the broadcast program of the EPG data and detects the broadcast start time 21:00 and the broadcast end time 23:00 of the particular program. The recording control unit 4, in response to a recording instruction from the remote controller, instructs the video/audio compression recording control unit 6 to record the program being viewed, and instructs the timer control unit 2 to set the timer in such a manner that the recording is stopped at the broadcast end time. The recording control unit 2, in response to a recording stop instruction from the timer control unit 6 at the broadcast end time, instructs the video/audio compression recording control unit 6 to end the recording operation.

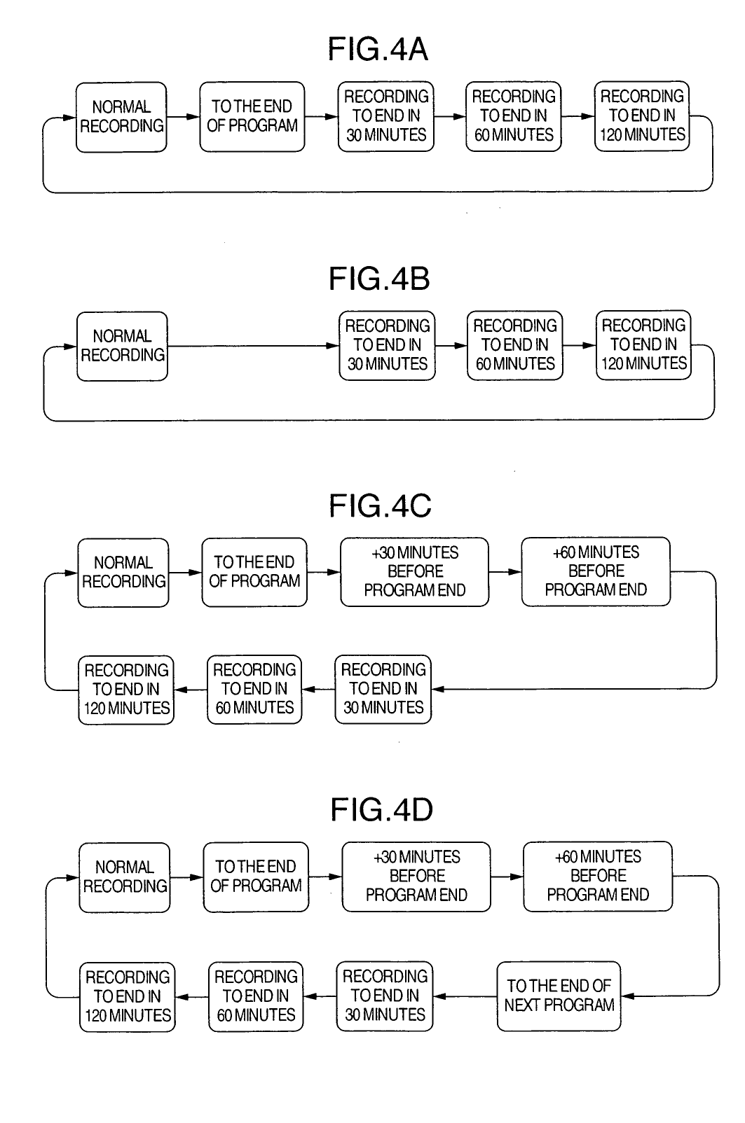

Next, the user interface for setting the recording end time is explained. The recording control unit 4 displays the recording end time as shown in FIG. 4A to permit the viewer to set the recording end time. The recording control unit 4, upon receipt of the notification that the recording button of the remote controller is depressed while viewing, displays “normal recording” in a part of the display unit, and waits for the depression of the “enter” button. The “normal recording” indicates the operation mode in which the video recording is continued until the viewer depresses the stop button of the remote controller. According to this embodiment, the depression of the “enter” button is hereinafter assumed to be the selective input by the viewer. In the case where the viewer depresses the recording button of the remote controller again, the recording control unit 4 displays “to the end of program” indicating that the broadcast end time acquired from the EPG data is set as the recording end time. In response to this display, the viewer depresses the “enter” button. Then, the recording control unit 4, as described above, sets the recording end time as the broadcast end time of EPG.

After displaying “to the end of program”, the viewer further depresses the recording button. Then, the recording control unit 4 displays “recording to end in 30 minutes” indicating that the recording is continued for 30 minutes more from the present time. The viewer depresses the “enter” button. The recording control unit 4 instructs the timer control unit 2 to set the timer to end the recording operation upon lapse of 30 minutes from the present time.

After display of “recording to end in 30 minutes”, the viewer further depresses the recording button. The recording control unit 4 displays “recording to end in 60 minutes” indicating that the recording operation is continued for 60 minutes from the present time. As in the above-mentioned case, the viewer depresses the “enter” button. Then, the recording control unit 4 sets the timer in such a manner as to end the recording operation upon lapse of 60 minutes from the present time. The viewer depresses the recording button, and then the recording control unit 4 displays “recording to end in 120 minutes” indicating that the recording operation is continued for 120 minutes from the present time. After display of “recording to end in 120 minutes”, the viewer depresses the recording button, and then the “normal recording” is displayed again. This process is repeated.

The embodiment explained in FIGS. 3A, 3B represents a case in which the EPG data can be normally acquired. Nevertheless, the EPG data may not be acquired normally. The EPG data cannot be acquired normally, for example, in the case where the broadcast channel distributing the EPG data is not received or in the case where the server providing the EPG data cannot be accessed due to a network fault. Especially, the EPG data may not be acquired normally from the broadcast wave in view of the fact that the EPG data is distributed only several times a day and the acquisition of the EPG data takes a considerable time.

In the case where the EPG data cannot be normally acquired, as shown in FIGS. 3C, 4B, the recording end time is determined. In this case, as shown in FIG. 4B, the broadcast end time of the broadcast program being viewed cannot be acquired from the EPG data. Therefore, the step of displaying “to the end of program” is omitted.

More specifically, the recording control unit 4, upon receipt of the notification that the recording button of the remote controller is depressed while viewing, displays “normal recording” in a part of the display unit, and waits for the depression of the “enter” button. At the same time, the validity of the EPG data is checked, and assume that it is determined that the EPG is valid. Upon the next depression of the recording button by the viewer, the recording control unit 4 displays “recording to end within 30 minutes” indicating that the recording operation is continued for 30 minutes from the present time, without displaying “to the end of program” (i.e. without executing the process of detecting the program end time from the EPG data and setting it as the recording end time). In the case where “recording to end in 120 minutes” is selected in accordance with the broadcast time of the broadcast program, as shown in FIG. 3C, the program is recorded for 120 minutes after the recording start instruction issued by the user at 21:10, and the recording is ended at 23:10.

Next, an example of the method of determining the validity or invalidity of the EPG data is explained. The normal broadcast data contains a program ID code to identify the program associated with the broadcast data. Therefore, the program ID code of the broadcast program is acquired during the unoccupied time of the program viewing or the program recording or during the program viewing or the program recording. This program ID data is contained also in the EPG data. Thus, the program ID code received is compared with the program ID code of the EPG data, and it is determined whether the program is broadcast in accordance with the EPG data acquired. In this way, the validity or invalidity of the EPG data is determined.

In order to detect the validity of the EPG data periodically, each broadcast channel is preferably set in receiving mode appropriately to acquire the program ID code of the broadcast program even while the video recording apparatus is not in operation (while not being viewed or in recording operation). By checking the validity of the EPG data periodically in this way, the EPG data can be positively acquired at the time of detection of invalidity.

Next, the method of setting the recording end time with the delay or change of the broadcast program by checking the EPG data according to the above-mentioned method is explained with reference to FIGS. 3A, 4C. In the example shown in FIG. 3B, the setting of the recording end time is explained with reference to a case in which the EPG data exists but the time information is displaced due to the extension of the preceding program.

Assume that the viewer issues a recording start instruction by the remote controller at 21:10 to record a predetermined program (movie) to be broadcast from 21:00. Unlike in the case of FIG. 3A, the preceding program (baseball) is extended and the contents thereof not reflected in the EPG data. The program end time acquired from the EPG data, therefore, is different from the end time of the program actually broadcast. In the recording control unit 4, therefore, the sum of the program end time acquired from the EPG data and the delay time of the preceding program (baseball) is regarded as the recording end time, and the timer control unit 2 is instructed to set the timer to stop the recording at the broadcast end time. The delay time of the preceding program (baseball) varies depending on the situation. As shown in FIG. 4C, therefore, “to the end of program”, “+30 minutes before end of program” and “+60 minutes before end of program” are sequentially displayed to leave the selection to the viewer. The contents of the recording end time to be selected can be displayed and the setting operation can be performed in the same way as in FIGS. 4A, 4B.

The baseball program or the like which is often extended is sometimes followed by a program prepared for the extension. In such a case, the EPG data contains the program prepared for the extension of the preceding program. At the time of extending the preceding program, therefore, “to the end of program” or the like is selectively displayed, and using the EPG data, the broadcast end time of the broadcast program is acquired.

Further, as shown in FIG. 4D, in order to perform the recording operation positively in spite of the extension of the preceding program, the end time of the program following the program to be recorded may be acquired from the EPG data and “to the end of next program” indicating that the recording is continued to the end time of the next program is displayed to leave the selection to the viewer.

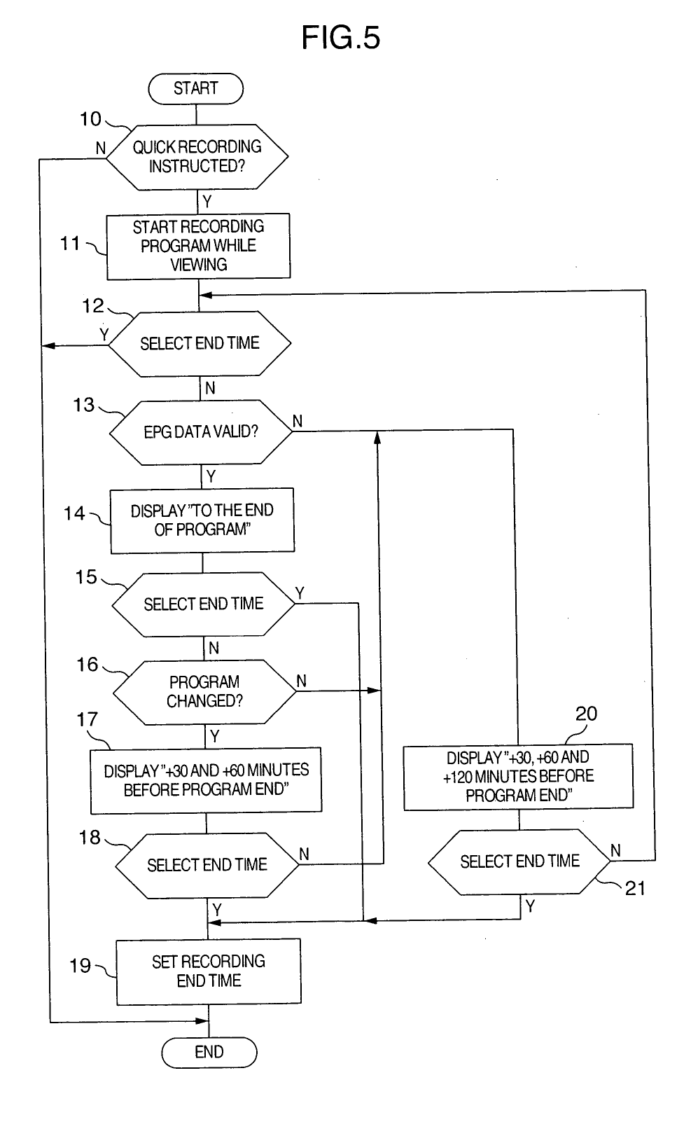

Next, the detailed flow of the process in the user interface for setting the recording end time by the remote controller shown in FIG. 4 is explained with reference to FIG. 5. First, it is determined whether the recording instruction is issued while viewing or not (quick recording instruction or not) (step 10). This is to omit the process of this flow in the case where the recording is reserved or going on.

In response to the quick recording instruction, “normal recording” is displayed and the program being viewed starts to be recorded (step 11), followed by setting the recording end time. At the same time, it is determined whether the “enter” button is depressed or otherwise some operation for selecting the end time is performed or not (step 12). In this stage, “normal recording” is on display, and therefore the depression of the “enter” button is regarded to have set the recording condition under which the recording operation is stopped by depression of the “stop” button. Therefore, the recording end time is not specifically set.

In the case where the “enter” button is not depressed, on the other hand, it is determined whether the EPG data is valid or invalid (step 13). In the case where the EPG data is invalid, +30 minutes, +60 minutes and +120 minutes from the present time before the end of recording are sequentially displayed (steps 20, 21). And when the “enter” button is depressed (step 21), the recording time then on display is added to the present time to set the recording end time (step 19).

In the case where the EPG data is valid, on the other hand, the end time of the program to be recorded is acquired from the EPG data, and “to end of this program” is displayed (step 14). It is determined whether the “enter” button has been depressed (step 15), and in the case where the “enter” button is depressed, the program end time in the EPG data is set as the recording end time (step 19). Unless the “enter” button is depressed, on the other hand, it is determined whether the program is not extended and the program is broadcast according to the EPG data (step 16).

In the case where the program is broadcast according to the EPG data, +30 minutes, +60 minutes and +120 minutes before the end of recording from the present time are sequentially displayed (steps 20, 21). And when the “enter” button is depressed (step 21), the recording time then on display is added to the present time to set the recording end time (step 19).

In the case where the broadcast program is extended, on the other hand, the recording program end time of +30 minutes and +60 minutes acquired from the EPG data are sequentially displayed (steps 17, 18). And when the “enter” button is depressed (step 18), the sum of the recording program end time acquired from the EPG data and any of the extension time is set as the recording end time (step 19).

Unless the “enter” button is depressed at step 18, +30 minutes, +60 minutes and +120 minutes before the end of recording from the present time are sequentially displayed (steps 20, 21). And when the “enter” button is depressed (step 21), the recording time then on display is added to the present time to set the recording end time (step 19).

The processing flow shown in FIG. 5 takes the program extension into consideration. In the case where the program extension is not taken into consideration as shown in FIGS. 4A, 4B, however, the process of steps 16 to 18 may be done without.

According to this invention, even in the manual recording while viewing, the process is continued until the end of the broadcast program to be recorded. Therefore, the storage area is not wastefully used, and the storage efficiency of the apparatus is improved

Also, even in the case where the broadcast time of the broadcast program is changed, the recording operation can be performed beyond the end time of the desired broadcast program, and therefore the recording program is not suspended midway.

Further, the recording end time set for the recording while viewing are displayed sequentially. Therefore, the operability remains unchanged from the prior art and the complication of the operation which otherwise might occur due to an improved function is prevented.

It should be further understood by those skilled in the art that although the foregoing description has been made on embodiments of the invention, the invention is not limited thereto and various changes and modifications may be made without departing from the spirit of the invention and the scope of the appended claims.

1. A recording control method for a video recording apparatus to record a broadcast program, comprising the steps of:
acquiring the program table information of the broadcast program;
receiving a recording instruction for the broadcast program being viewed;
acquiring the program broadcast end time of the broadcast program from the program table information;
displaying the confirmation as to whether the acquired program broadcast end time is set as a recording end time; and
recording, upon receipt of the confirmation input, the broadcast program until the recording end time from the time of the recording instruction.

2. A recording control method according to claim 1, further comprising the step, in the case where the broadcast program is different from the program registered in the program table, of sequentially displaying the setting of the broadcast end time of the program acquired with reference to the program table based on the present time and the setting of the sum of the broadcast end time and a predetermined recording time as the recording end time, and selecting one of the settings and continuing the recording to the recording end time corresponding to the selected setting.

3. A recording control method according to claim 2.
wherein the ID information contained in the broadcast program is compared with the ID information on the program obtained from the program table based on the present time, and the broadcast program is compared with the program registered in the program table.

4. A recording control method according to claim 2, further comprising the steps of:
adding the recording time of 30 minutes to the broadcast end time as a recording end time;
adding the recording time of 60 minutes to the broadcast end time as a recording end time; and
adding the recording time of 120 minutes to the broadcast end time as a recording end time.

5. A recording control method according to claim 2, further comprising the steps of:
acquiring the broadcast end time of the broadcast program following the current broadcast program with reference to the program table based on the present time; and
displaying the confirmation as to whether the acquired broadcast end time is determined as the recording end time.

6. A recording control method according to claim 1, further comprising the step, in the case where the program table information of the broadcast program cannot be acquired, of sequentially displaying the setting of the sum of the present time and a predetermined recording time as the recording end time, and selecting one of the settings and continuing the recording to the recording end time corresponding to the selected setting.

7. A recording control method according to claim 6, further comprising the steps of:
adding the recording time of 30 minutes to the broadcast end time to determine a recording end time;
adding the recording time of 60 minutes to the broadcast end time to determine a recording end time; and
adding the recording time of 120 minutes to the broadcast end time to determine a recording end time.

8. A video recording apparatus for recording a broadcast program, comprising:
an operating unit for receiving a recording instruction from the viewer of the broadcast program;
a program table information acquisition unit for acquiring the program table information of the broadcast program;
a program table information storage unit for storing the program table information; and
a recording control unit for displaying the confirmation as to whether the acquired program broadcast end time is regarded as the recording end time, and upon confirmation input, recording the broadcast program from the time of the recording instruction the recording end time.

9. A video recording apparatus according to claim 8,
wherein in the case where the broadcast program is different from the program registered in the program table, the recording control unit sequentially displays the setting of the program broadcast end time acquired with reference to the program table based on the present time and the setting of the sum of the broadcast end time and a predetermined recording time as the recording end time, and selects one of the settings and continues the recording to the recording end time corresponding to the selected setting.

10. A video recording apparatus according to claim 9,
wherein the recording control unit compares the ID information contained in the broadcast program with the ID information on the program obtained from the program table based on the present time, and compares the broadcast program with the program registered in the program table.

11. A video recording apparatus according to claim 9,
wherein the recording control unit adds the recording time of 30 minutes to the broadcast end time as a recording end time, adds the recording time of 60 minutes to the broadcast end time as a recording end time, or adds the recording time of 120 minutes to the broadcast end time as a recording end time.

12. A video recording apparatus according to claim 9,
wherein the recording control unit acquires the broadcast end time of the broadcast program following the current broadcast program with reference to the program table based on the present time, and displays the confirmation as to whether the acquired broadcast end time is regarded as the recording end time.

13. A video recording apparatus according to claim 8,
wherein in the case where the program table information of the broadcast program cannot be acquired, the setting of the sum of the present time and a predetermined recording time as the recording end time is sequentially displayed, and one of the settings is selected while continuing the recording to the recording end time corresponding to the selected setting.

14. A video recording apparatus according to claim 13,
wherein the recording control unit adds the recording time of 30 minutes to the broadcast end time as a recording end time, adds the recording time of 60 minutes to the broadcast end time as a recording end time, or adds the recording time of 120 minutes to the broadcast end time as a recording end time.

15. A video recording apparatus for recording a broadcast program, comprising:
a recording control unit for recording the broadcast program;
a program table information storage unit for storing the broadcast time of the program;
an operating instruction input unit for receiving the recording instruction input and the recording time select input of the viewer; and
a display means for displaying the broadcast program and a plurality of the recording end time select information;
wherein the display means sequentially displays the recording end time select information sequentially based on the broadcast time information of the program of the program table information storage unit in the case where the recording instruction is input to the operating inspection input unit, and
wherein when the recording instruction is input to the operating instruction input unit, the recording control unit starts the recording of the broadcast program and continues the recording operation until the recording end time determined by the recording end time select information selected in accordance with the recording time select instruction input from the operating instruction input unit.

16. A video recording apparatus according to claim 15,
wherein the display means sequentially displays the setting for ending the recording when a recording stop instruction is input to the operating instruction input unit, the setting for ending the recording upon lapse of a first time from the start of recording, the setting for ending the recording operation upon lapse of a second time from the start of recording, and the setting for ending the recording upon lapse of a third time from the start of recording.

17. A video recording apparatus according to claim 15,
wherein the display means sequentially displays the setting for ending the recording when a recording stop instruction is input to the operating instruction input unit, the setting for ending the recording at the broadcast end time of the broadcast program corresponding to the time when the recording instruction is input, the setting for ending the recording upon lapse of a first time from the start of recording, the setting for ending the recording upon lapse of a second time from the start of recording, and the setting for ending the recording upon lapse of a third time from the start of recording.

18. A video recording apparatus according to claim 15,
wherein the display means sequentially displays the setting for ending the recording when a recording stop instruction is input to the operating instruction input unit, the setting for ending the recording at the broadcast end time of the broadcast program corresponding to the time when the recording instruction is input, the setting for ending the recording upon lapse of a first time from the broadcast end time, the setting for ending the recording upon lapse of a second time from the broadcast end time, the setting for ending the recording upon lapse of the first time from the start of recording, the setting for ending the recording upon lapse of the second time from the start of recording and the setting for ending the recording upon lapse of the third time from the start of recording.

19. A video recording apparatus according to claim 15,
wherein the display means sequentially displays the setting for ending the recording when a recording stop instruction is input to the operating instruction input unit, the setting for ending the recording at the broadcast end time of the broadcast program corresponding to the time when the recording instruction is input, the setting for ending the recording upon lapse of a first time from the broadcast end time, the setting for ending the recording upon lapse of a second time from the broadcast end time, the setting for ending the recording at the broadcast end time of the broadcast program following the broadcast program corresponding to the time when the recording instruction is input, the setting for ending the recording upon lapse of the first time from the start of recording, the setting for ending the recording upon lapse of the second time from the start of recording, and the setting for ending the recording upon lapse of the third time from the start of recording.
